(19) United States
(12) Patent Application Publication
(10) Pub. No.: US 2026/0105520 A1
(43) Pub. Date: Apr. 16, 2026

(54) PRIVACY-PRESERVING EXCHANGE PROTOCOLS FOR EXCHANGE DISCOVERY BY ARTIFICIAL INTELLIGENCE ORCHESTRATORS

(71) Applicant: Rutter Family Investment LLC, Pittsburgh, PA (US)

(72) Inventors: Kevin Walter Rutter, New York, NY (US); Brandon Stiles, New York, NY (US); David E. Rutter, London (GB)

(21) Appl. No.: 19/360,812

(22) Filed: Oct. 16, 2025

Related U.S. Application Data
(60) Provisional application No. 63/708,177, filed on Oct. 16, 2024.

(51) Int. Cl. G06Q 40/04; G06N 5/02

(52) U.S. Cl. CPC G06Q 40/0421; G06N 5/02

(57) ABSTRACT

Disclosed herein are systems, methods, and computer-readable media for an exchange management platform that obtains, using artificial intelligence (AI) orchestrators, a set of available exchanges based on a set of exchange protocols. In some implementations, a first command set directs one or more AI orchestrators to generate, as output, a set of resources satisfying a first protocol from the set of exchange protocols. A second command set and a second protocol from the set of exchange protocols can then be provided, as input, to the one or more AI orchestrators, causing the one or more AI orchestrators to determine a set of available exchanges for transferring a resource between two entities. The set of available exchanges can be obtained from the one or more AI orchestrators and display of a graphical layout based on the set of available exchanges can be caused.

### CROSS-REFERENCE TO RELATED APPLICATIONS

This application claims priority to and the benefits of U.S. Provisional Application No. 63/708,177, titled “ARTIFICIAL INTELLIGENCE ORCHESTRATION OF ILLIQUID ASSET CLASS TRADING,” filed on Oct. 16, 2024. The content of the aforementioned application is herein incorporated by reference in its entirety.

### TECHNICAL FIELD

The systems, methods, and computer-readable media disclosed herein relate generally to transmission of information between artificial intelligence (AI) models according to a set of exchange protocols. In some use cases, the AI models can be implemented in relation to the trading of financial assets. For example, the output of AI models can be used to identify and automatically execute transactions for illiquid financial assets.

### BACKGROUND

In the early 2000s, many financial asset classes transitioned to digital trading venues and exchanges. These asset classes included equities, foreign exchange, government bonds (treasuries), futures, and options. These markets shared several features, including standardized and fungible instruments, centralized market infrastructure for custody and order matching, and instruments that were easily discoverable through search algorithms and simple user interfaces.

The adoption of digital trading across several other large asset classes has been significantly slower. Asset classes that have struggled to transition to digital-first trading venues generally include less liquid markets such as corporate bonds, private credit, municipal bonds, and over-the-counter (OTC) swaps. These markets are often traded by phone or through peer-to-peer messaging. Many issuances and instruments remain held in inventory by market participants and generally are not as actively traded as those in fully digital markets.

### BRIEF DESCRIPTION OF THE DRAWINGS

FIG. 1 shows an example computing environment that includes an exchange management platform, in accordance with some implementations of the present technology.

FIG. 2A is an example communication environment including a communication session in which a first artificial intelligence (AI) orchestrator and a second AI orchestrator communicate with one another, in accordance with some implementations of the present technology.

FIG. 2B is another example communication environment including a communication session in which a first AI orchestrator and a second AI orchestrator communicate with one another, in accordance with some implementations of the present technology.

FIG. 3 shows an example computing environment that includes a transaction management platform, in accordance with some implementations of the present technology.

FIG. 4 is a flowchart depicting an example method of facilitating exchanges between entities using AI orchestrators, in accordance with some implementations of the present technology.

FIG. 5 is a block diagram of an example transformer, in accordance with some implementations of the present technology.

FIG. 6 is a block diagram that illustrates an example of an AI system in which at least some operations described herein can be implemented.

FIG. 7 is a block diagram that illustrates an example of a computer system in which at least some operations described herein can be implemented.

The drawings have not necessarily been drawn to scale. For example, some components and/or operations may be separated into different blocks or combined into a single block for the purposes of discussion of some of the implementations of the disclosed system. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

Many types of resources (e.g., physical goods, digital assets, illiquid assets) do not have standardized protocols/markets for exchange, often requiring entities that wish to exchange these resources with one or more other entities (e.g., transfer ownership to and/or receive ownership from those entities) to contact the one or more entities directly and arrange an exchange on mutually beneficial terms. Although such exchanges can be facilitated on digital platforms, existing digital platforms often lack features for automatically detecting the availability of resources that are of interest to an entity and/or for automatically determining a set of exchanges that the entity can engage in with one or more other entities to obtain those resources. Furthermore, in order to discover that an exchange for a desired resource is available, an entity must typically reveal private information (e.g., resource preferences, current ownership of resources, and the like) to another entity with which the entity is seeking to make an exchange. This disclosure of private information can be particularly undesirable when the entities do not ultimately settle upon an exchange of resources, as the entity seeking to make an exchange can sacrifice future bargaining leverage without obtaining a desired resource in return.

As a particular example of a resource, illiquid asset classes have struggled to transition to a digital trading venue or marketplace for several reasons, including the difficulty of searching for potential trading opportunities within unstructured inventory data, the risk of information leakage about the inventory holdings or trading interests of market participants, and the relatively slow speed of an analog workflow preventing the process from being scaled. Conventional illiquid asset class trading systems rely on human portfolio managers and traders to identify the need for a portfolio reallocation, gather market information, negotiate transactions, solicit bids, make offers and counteroffers, and execute transactions. A common workflow for executing transactions in an illiquid asset class market involves a portfolio manager communicating potential transactions to a trader, who then takes these instructions and begins the process of finding the best execution options. This involves evaluating current market conditions, liquidity, and learning of potential pricing across electronic transaction management platforms. The trader can call certain dealers or market participants for information on the market to try to learn more generally about the market and specifically about who may have inventory or a willingness to trade. Often, during these conversations, the trader is careful and selective about what information or how much to reveal to different market participants. Each conversation with each counterparty can be different, depending on the level of trust in the relationship or how likely it is that the conversation will lead to a mutually acceptable exchange. After gathering some information about the market, the trader may then gather quotes from the market, compare those quotes, and consult with the portfolio manager to finalize decisions about which quote to accept or what counteroffers to make.

Relying on humans for all of these tasks can be resource-intensive, slow, and prone to inaccuracies. Portfolio managers and traders typically rely on unstructured data spread among different inventories, which is then manually integrated and analyzed to assess the optimal trading strategy. The unstructured nature of the data makes it difficult to parse with a traditional deterministic search. For instance, because different brokers can offer different financial contract products differing in their material terms or including bespoke terms, it can be difficult for a human using deterministic search to identify all comparable products. Manually extracting and analyzing the information to compare illiquid assets is often inefficient and returns incomplete results due to the complexity involved.

In addition to being procedurally inefficient, the conventional approach to trading illiquid assets also raises privacy concerns. Market participants do not want unnecessary information regarding their inventory holdings or trading interest to leak more broadly to the market, as this can jeopardize the bargaining power of the market participant. As a result, not enough information about potential transaction opportunities is shared, limiting liquidity. The efficiency of the market is also limited by the speed of the human traders, who need minutes or even hours to source information from different market participants. This process is not scalable, given the need to hold several discussions between many different market participants to execute a single transaction. These limitations suppress activity in the secondary market.

Disclosed herein are systems, methods, and computer-readable media for obtaining, using artificial intelligence (AI) orchestrators, a set of available exchanges based on a set of exchange protocols. In some implementations, the present technology enables AI orchestrators associated with different entities to communicate with one another and exchange information in a manner consistent with sets of exchange protocols associated with those entities. Thus, the set of available exchanges can be automatically determined by the AI orchestrators according to the preferences of the entities and caused to be displayed, to one or more of the entities, without revealing other information communicated between the AI orchestrators. This automated discovery process thereby provides a technical solution to protecting the privacy of the entities while still enabling the set of available exchanges to be obtained, as private information is exchanged only between the AI orchestrators rather than between the entities themselves.

In some implementations, the present technology includes implementing an AI-augmented asset search and discovery process. Market participants are enabled to securely upload information regarding their inventory or potential transaction ideas to a transaction management platform, from which the information would be shared with the broader market. AI orchestrators representing the market participants then search the transaction management platform for transaction opportunities matching the trading objectives of their associated market participants. Using AI orchestrators to search the transaction management platform leverages the ability of AI systems to search through unstructured data at scale in a more efficient and accurate manner than humans or deterministic search algorithms.

When an AI orchestrator recognizes an available exchange (e.g., an opportunity for a mutually acceptable transaction), the AI orchestrator can initiate a negotiation with a counterparty AI orchestrator representing a counterparty, or a non-affiliated market participant that acts as the other party to the transaction. When multiple such opportunities for a transaction match exist, one AI orchestrator can initiate and carry out several such negotiations simultaneously, eliminating much of the delay present in the current system of analog illiquid asset trading and scaling the capabilities of human traders and portfolio managers. In some implementations, negotiations between AI orchestrators happen at scale, between all counterparties, and across all assets simultaneously.

In some implementations, during these negotiations, an AI orchestrator intelligently reveals and conditionally shares information based upon how the negotiations between the AI orchestrator and the counterparty AI orchestrator are progressing. Specific relevant criteria for conditionally revealing more information include an analysis of how credible the AI orchestrator perceives a counterparty to be and how likely the counterparty is to execute a transaction with the market participant for a particular financial instrument. As each negotiation between AI orchestrators advances closer to a match and the perceived probability of a match for each side increases, the willingness of each AI orchestrator to share more information about trading intentions and available inventory dynamically adjusts to facilitate completion of a transaction. Where an AI orchestrator no longer believes there is a credible probability of a transaction occurring that justifies the risk of more information sharing, the AI orchestrator can end the negotiation. After the AI orchestrators negotiate with each other, each respective AI orchestrator can return recommendations to each market participant and/or execute any finalized transactions unilaterally.

In some implementations, negotiations between AI orchestrators occur on a transaction management platform, which maintains the confidentiality of any revealed information. Confidentiality can be improved using a credentialing system that allows a market participant to reveal or hide the market participant’s identity. Market participants can further customize the amount of information revealed during the search and discovery process as well as the negotiation process (e.g., using a set of exchange protocols). Market participants can also determine how many counterparties the market participant wants to involve in a negotiation, whether bilateral or multilateral, and the negotiation content will only be shared with those participants. When desired, the negotiation occurs within a protected space on the transaction management platform where the counterparties themselves do not have access to the negotiation details, only to the transaction ideas resulting from that negotiation, allowing a transaction to be executed with a reduced risk of disclosing too much information to a counterparty as compared to other exchange discovery methods.

### Example Implementations of an Exchange Management Platform

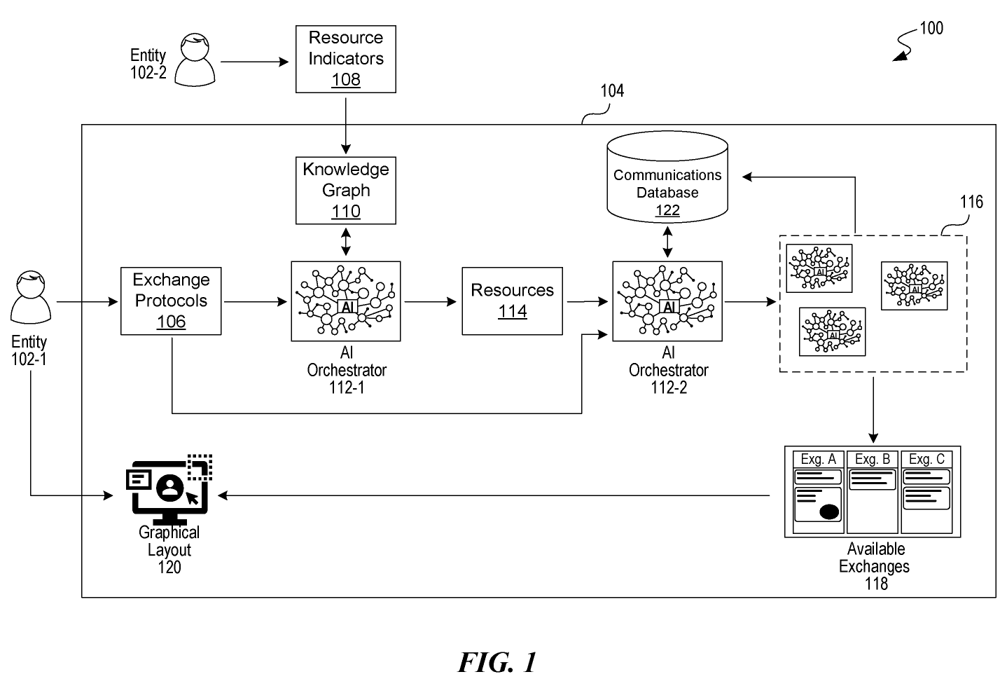

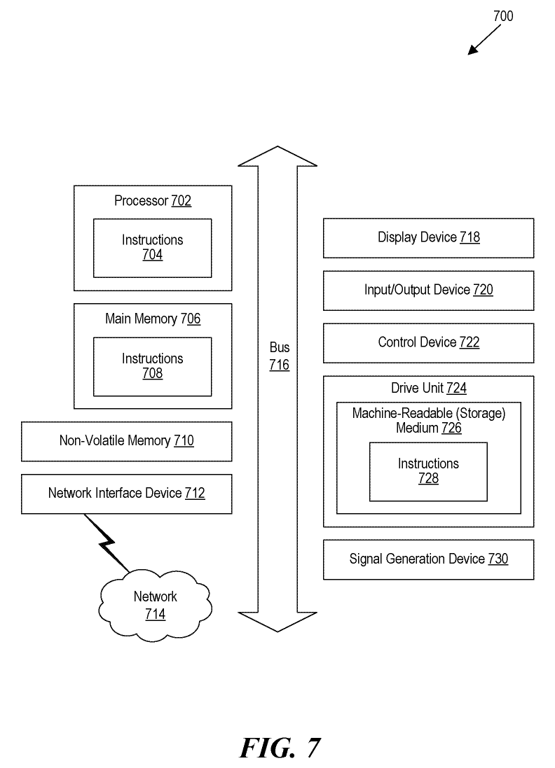

FIG. 1 shows an example computing environment 100 that includes an exchange management platform 104, in accordance with some implementations of the present technology. The computing environment 100 includes entities 102-1 and 102-2, the exchange management platform 104, a set of exchange protocols 106, a set of resource indicators 108, a knowledge graph 110, AI orchestrators 112-1 and 112-2, a set of resources 114, a communication session 116, a set of available exchanges 118, a graphical layout 120, and a communications database 122. The exchange management platform 104 can be implemented using components of the example computer system illustrated and described in more detail with reference to FIG. 7. Likewise, implementations of the example computing environment 100 can include different and/or additional components or can be connected in different ways.

The first entity 102-1 is an individual or organization interacting with the exchange management platform 104, providing input data such as a set of exchange protocols 106. The set of exchange protocols 106 includes one or more protocols associated with exchanges of resources that the first entity 102-1 can participate in via the exchange management platform 104. For example, the set of exchange protocols 106 can include an exchange type protocol that specifies one or more types of resources the first entity 102-1 wishes to send and/or receive in an exchange of resources with another entity. In some implementations, the first entity 102-1 is an individual such as a portfolio manager or trader and uploads the set of exchange protocols 106 to the exchange management platform 104 as a document and/or image indicating (e.g., via a URL or spreadsheet) a list of desired resources for the entity, thereby serving as an exchange type protocol. Examples of resources that can be included in the list include any illiquid asset, such as corporate bonds, private credit, municipal bonds, and OTC swaps/derivatives. In some implementations, one or more exchange protocols from the set of exchange protocols 106 are associated with the first entity 102-1 but are not obtained (e.g., actively acquired or passively received) directly from the first entity 102-1 by the exchange management platform 104. Instead, the one or more exchange protocols can be obtained from a third party and/or can be applied automatically to a group of entities using the exchange management platform 104.

In some implementations, the set of exchange protocols 106 includes one or more additional protocols. A data quality protocol can be included that specifies a quality level of data associated with available resources to be considered by the exchange management platform 104 on behalf of the first entity 102-1. For example, the first entity 102-1 can have a preference for only highly reliable data related to available resources (e.g., data directly from another entity in possession of a resource), such that resources identified as “available” are more likely to truly be available. Alternatively, the first entity 102-1 can have a preference for considering any available data related to available resources (e.g., publicly available information, such as from the Internet), which can result in false identification of available resources but also in the consideration of a wider range of available resources. A regulatory protocol can also be included that specifies one or more regulations governing the exchange of resources with which the first entity 102-1 desires to and/or is required to comply. For example, the one or more regulations can include securities regulations and/or other financial regulations. A privacy protocol can be included that specifies information the first entity 102-1 is willing to share with other entities via the exchange management platform 104. For example, the privacy protocol can indicate that a name or a corporate affiliation of the first entity 102-1 remain private while other information associated with the first entity 102-1 can be shared. An exchange discovery protocol can also be included that specifies one or more behaviors for a first AI orchestrator 112-1 to discover available exchanges on behalf of the first entity 102-1, as described in more detail below. The examples of protocols provided herein are non-limiting, and other protocols associated with the exchange of resources via the exchange management platform 104 can be included in addition to or instead of the protocols described herein.

In other implementations, the set of exchange protocols 106 is scraped from a database maintained by the first entity 102-1 indicating preferred exchange protocols of the first entity 102-1. For example, the database may contain the current portfolio holdings, market projections, and/or financial targets of the first entity 102-1, thereby indicating exchange type protocols associated with the entity. In some implementations, the exchange management platform 104 uses application programming interfaces (APIs) supported by the database, which allows programmatic access to the input data. For example, a scraper can be written using a programming language to interact with the API of the database and extract exchange protocols such as those listed above. Similarly, a scraper written using a programming language can extract requests for specific resources the first entity 102-1 would like to exchange.

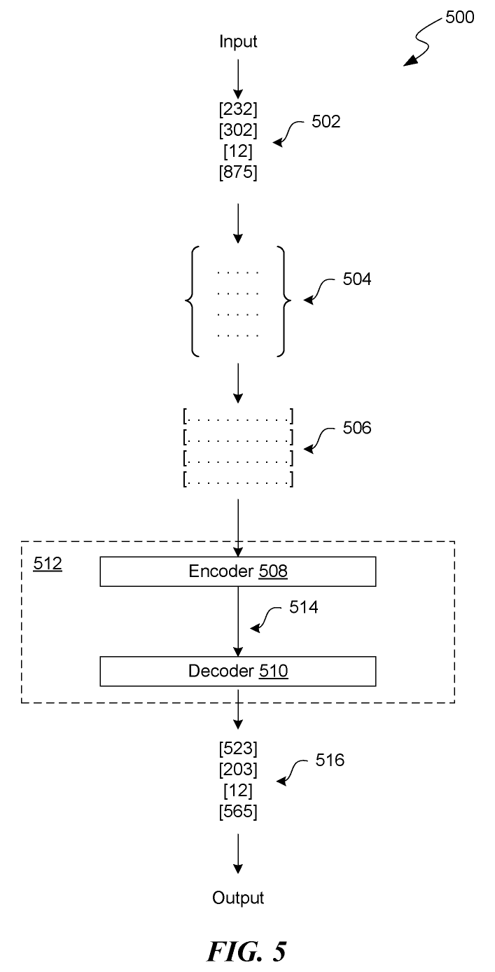

In some implementations, a plurality of resource indicators 108, each of which indicates an availability of one or more resources associated with a second entity 102-2 (e.g., resources available for exchange by the second entity 102-2), is accessed by the exchange management platform 104 from a knowledge graph 110. The second entity 102-2 can be an individual or organization other than the first entity 102-1 with which the first entity 102-1 can exchange resources (e.g., via the exchange management platform 104). The knowledge graph 110 can be a graph of one or more vector embeddings (e.g., an embedding 506, as described in relation to FIG. 5 below) representing, in a machine-readable format that can be parsed by an AI orchestrator, the plurality of resource indicators 108 and/or the relationships between those indicators. The exchange management platform 104 can access the plurality of resource indicators 108 by obtaining, storing, and/or otherwise interacting with the vector embeddings.

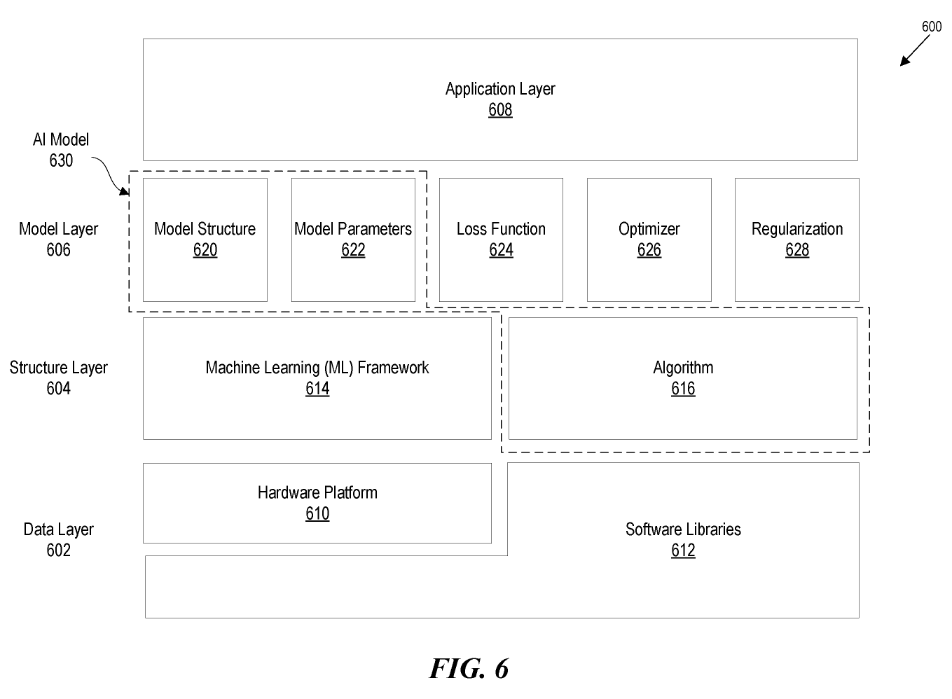

The exchange management platform 104 can use one or more AI orchestrators to process data for dynamically facilitating exchanges of resources. An AI orchestrator is a software component that invokes one or more AI models or algorithms, applies the models to an input, and processes the output of the models to automatically perform functions of the exchange management platform 104, such as an output associated with a resource available for exchange. For example, the one or more AI orchestrators may include one or more features of the transformer 512 and/or the AI system 600 described below in relation to FIGS. 5 and 6, respectively. Additionally or alternatively, the one or more AI orchestrators may include a commercial AI model such as GPT-4 or Claude 3.7 Sonnet.

In some implementations, a first AI orchestrator 112-1 is provided, as input, a first protocol from the set of exchange protocols 106 and a first command set. The first command set is a set of machine-readable and/or natural language instructions directing the first AI orchestrator 112-1 to generate a set of queries for searching a subset of the knowledge graph 110 for a set of resources 114 for which the first entity 102-1 can perform an exchange according to the first protocol. The first protocol is a protocol specifying a data quality protocol and/or at least one of an exchange type protocol or a regulatory protocol, which thereby provides guidance to the first AI orchestrator 112-1 regarding the particular resources that the first entity 102-1 can exchange (e.g., desires to exchange, is permitted by regulation to exchange) and the data sources to consider while searching for those resources. For example, the first AI orchestrator 112-1 can search a subset of the knowledge graph 110 that is based on the data quality protocol (e.g., a subset that includes data of an equal or higher quality than that specified by the data quality protocol), enabling the first AI orchestrator 112-1 to identify resources consistent with the data quality preferences of the first entity 102-1. Furthermore, searching only the subset of the knowledge graph 110 conserves computational resources that would otherwise be spent on searching the entire knowledge graph 110 for information about resources that would ultimately not satisfy the data quality preferences of the first entity 102-1.

In some implementations, the exchange management platform 104 can organize the set of exchange protocols 106 and/or the first command set into a predefined schema that aligns with an expected input format of the first AI orchestrator 112-1. The obtained set of input data can be converted into numerical vector embeddings to represent words in a continuous vector space. For example, the exchange management platform 104 converts words or phrases into embeddings that can be processed by subsequent AI models. The text can be tokenized by splitting the text into individual words or tokens. For example, the exchange management platform 104 can use TF-IDF (Term Frequency-Inverse Document Frequency) to vectorize the tokenized text, which calculates the importance of a word in a document relative to a collection of documents. TF-IDF assigns a higher weight to words that are frequent in a specific document but rare across the entire dataset, thus capturing the significance of terms. Another method of vectorization is word embeddings, such as Word2Vec or GloVe (Global Vectors for Word Representation), which map words into a continuous vector space where semantically similar words are positioned closer together. Word2Vec, for example, uses neural networks to learn word associations from a large corpus of text, producing dense vectors that capture contextual relationships. Once the input data is vectorized, the input data is fed into the first AI orchestrator 112-1, which can be trained on historical exchange data, where each vectorized input is associated with specific actions and outcomes. During training, the first AI orchestrator 112-1 can learn to recognize patterns and relationships within the vectorized data that correlate with particular transaction preferences. The vectorized input data can be processed by the first AI orchestrator 112-1 to determine a subset of the knowledge graph 110 to search. For instance, if the vectorized data indicates a high frequency of terms related to “corporate bonds,” the first AI orchestrator 112-1 can identify that the first entity 102-1 has a preference for trading corporate bonds and search a subset of the knowledge graph 110 known to contain representations of corporate bonds. The plurality of resource indicators 108 can also be vectorized as described above and included in the knowledge graph 110.

In some implementations, the first AI orchestrator 112-1 is an analysis orchestrator from among one or more AI orchestrators that searches the knowledge graph 110 according to a set of constraints provided by a compliance orchestrator, also from among the one or more AI orchestrators. For example, the compliance orchestrator can be a specialized AI orchestrator that is configured to determine a set of relevant regulations with which the first entity 102-1 must comply when exchanging resources specified by the first protocol and/or first command set. Continuing with the same example, the compliance orchestrator can obtain information about the first entity 102-1 (e.g., an applicable legal jurisdiction, a list of practices the first entity 102-1 performs while acquiring resources) and a list of regulations and/or retrieve information about regulations (e.g., from the Internet) and determine which regulations apply to an exchange of resources by the first entity 102-1. Thus, the compliance orchestrator can determine that the first entity 102-1 would not comply with applicable regulations when acquiring one or more types/amounts of a resource and generate a set of constraints that accordingly instructs the analysis orchestrator to disregard possible exchanges that would result in non-compliance. Continuing with the same example, the analysis orchestrator can be a specialized AI orchestrator that is configured to access and extract the set of resources 114 from the knowledge graph 110 according to the set of constraints. The interrelationship between the compliance orchestrator and the analysis orchestrator improves computational efficiency, as (1) more specialized AI orchestrators can operate using fewer computational resources than general-purpose AI orchestrators and (2) the compliance orchestrator reduces the portions of the knowledge graph 110 searched by the analysis orchestrator, thereby enabling the analysis orchestrator to avoid processing excess information.

In some implementations, the first AI orchestrator 112-1 generates the set of queries by executing one or more predefined tools, which are code segments stored within the exchange management platform 104 that, when executed, perform certain deterministic actions that are often repeated during operation of the exchange management platform 104. For example, a tool can be included for determining a subset of the knowledge graph 110 to query based on one or more data quality protocols, identifying names of resources within a command set, and the like. Executing the one or more predefined tools further improves computational efficiency of the exchange management platform 104, as the repeated execution of deterministic code is less computationally expensive and error-prone than relying entirely on the non-deterministic reasoning capabilities of the first AI orchestrator 112-1 to generate the set of queries.

After the set of queries is generated, the first AI orchestrator 112-1 can search, using the set of queries, the subset of the knowledge graph 110 for a set of resources 114 satisfying the first protocol (e.g., a set of resources where each included resource is consistent with each constraint specified in the first protocol). For example, where the first protocol includes an exchange type protocol specifying to exchange only corporate bonds and a regulatory protocol that permits exchange of corporate bonds, the set of resources 114 can include corporate bonds and exclude other resources that are also represented in the knowledge graph 110. Although the first protocol and the first command set are described herein as being provided to the first AI orchestrator 112-1, in other implementations, the first protocol and the first command set can be provided, as input, to one or more AI orchestrators that perform the functions of the first AI orchestrator 112-1 as described herein.

The exchange management platform 104 can obtain the set of resources 114 from the first AI orchestrator 112-1 (and/or other AI orchestrators) and provide, as input, a second protocol from the set of exchange protocols 106 and a second command set to a second AI orchestrator 112-2. The second command set is a set of machine-readable and/or natural language instructions directing the second AI orchestrator 112-2 to perform one or more actions to determine a set of available exchanges 118, which includes one or more exchanges for transferring at least one resource from the set of resources 114 between the second entity 102-2 and the first entity 102-1. Thus, when an exchange from the set of available exchanges 118 is performed by the first entity 102-1, the first entity 102-1 can obtain and/or transfer away one or more resources, the one or more resources satisfying the set of exchange protocols 106 (e.g., are consistent with each of the preferences and/or regulations described therein). For example, the second command set can first direct the second AI orchestrator 112-2 to establish a communication session 116 with one or more other AI orchestrators associated with the second entity 102-2. The communication session 116 is a communicative coupling between the second AI orchestrator 112-2 and the one or more other AI orchestrators via which information can be transmitted between the AI orchestrators coupled thereby. Continuing with the same example, the second command set can then direct the second AI orchestrator 112-2 to, during the communication session 116, provide information to the one or more other AI orchestrators in accordance with the second protocol (e.g., following the constraints specified in a privacy protocol and/or an exchange discovery protocol). The second protocol can be a protocol specifying at least a privacy protocol and/or an exchange discovery protocol, which thereby provides guidance to the second AI orchestrator 112-2 regarding a manner in which the second AI orchestrator 112-2 provides information during the communication session 116. The second AI orchestrator 112-2 can thereby be constrained to only reveal information about the first entity 102-1 that the first entity 102-1 has authorized to be shared and/or to communicate with the other AI orchestrators using behaviors (e.g., negotiation tactics, specific methods of requesting information about resources) that are approved by the first entity 102-1. Again continuing with the same example, the second command set can direct the second AI orchestrator 112-2 to determine, based on the communication session 116, the set of available exchanges 118. Thus, the second command set directs the second AI orchestrator 112-2 to automatically obtain the set of available exchanges 118 that satisfies the set of exchange protocols 106, which would otherwise require large amounts of manual effort to obtain. Additionally, the set of available exchanges 118 is obtained without communicating any information to the second entity 102-2 directly, thereby enabling the first entity 102-1 to identify the set of available exchanges 118 while maintaining privacy of the first entity 102-1 in a manner that is not possible when the set of available exchanges 118 is determined via manual communication between the entities 102-1, 102-2. Although the second protocol and the second command set are described herein as being provided to the second AI orchestrator 112-2, in other implementations, the second protocol and the second command set can be provided, as input, to one or more AI orchestrators that perform the functions of the second AI orchestrator 112-2 as described herein.

In some implementations, the second AI orchestrator 112-2 is an exchange discovery orchestrator, which is a specialized AI orchestrator from among one or more AI orchestrators configured to discover available exchanges on behalf of the first entity 102-1. For example, the exchange discovery orchestrator can be trained to interpret privacy protocols and/or exchange discovery protocols (e.g., using a language model, as described below) to determine when to establish a communication session and/or how to provide information during an established communication session.

In some implementations, once the set of available exchanges 118 is obtained from the second AI orchestrator 112-2 (and/or other AI orchestrators), the exchange management platform 104 can cause display, to the first entity 102-1, of a graphical layout 120 based on the set of available exchanges 118. For example, the graphical layout 120 can be a visual element included in a graphical user interface (GUI) that lists and/or otherwise indicates each exchange from the set of available exchanges 118, enabling the first entity 102-1 to be informed of these exchanges and select one or more of the exchanges to perform. In such implementations, the graphical layout 120 can exclude information from the communication session 116 other than the set of available exchanges 118. Excluding this other information enables an available exchange between the first entity 102-1 and the second entity 102-2 to be determined and reported via the graphical layout 120 without revealing, to the first entity 102-1 and/or other entities viewing the graphical layout 120, any of the information transmitted to determine that exchange. This technique protects the privacy of the first entity 102-1 and the second entity 102-2, as information about the exchange preferences of these entities is obscured, while still allowing exchanges between the entities to be arranged. This privacy-preserving feature of the exchange management platform 104 is an improvement over other methods of transmitting information to determine the availability of an exchange where live entities obtain the information, as these methods are more likely to lead to private information about one or more involved entities being revealed.

In some implementations, the exchange management platform 104 includes a communications database 122, which is a combination of software/and or hardware for storing communication logs, or records of information generated during particular communication sessions between AI orchestrators. In such implementations, the exchange management platform 104 can store a communication log associated with the communication session 116 in the communications database 122. The second protocol, the communication log, and a third command set can then be provided to the second AI orchestrator 112-2 and/or one or more other AI orchestrators. The third command set can direct the second AI orchestrator 112-2 and/or one or more other AI orchestrators to establish, based on the communication log, a second communication session with a third AI orchestrator associated with a third entity. For example, the communication log may indicate that no available exchanges were determined within the communication session 116 between the second AI orchestrator 112-2 and the one or more AI orchestrators associated with the second entity 102-2 and therefore that further communications with the one or more AI orchestrators would not be productive. Thus, the second communication session is established with a third AI orchestrator associated with a third entity different from the second entity 102-2, as the third AI orchestrator can provide different information than the one or more AI orchestrators that can result in an available exchange, even where the communication session 116 did not result in an available exchange.

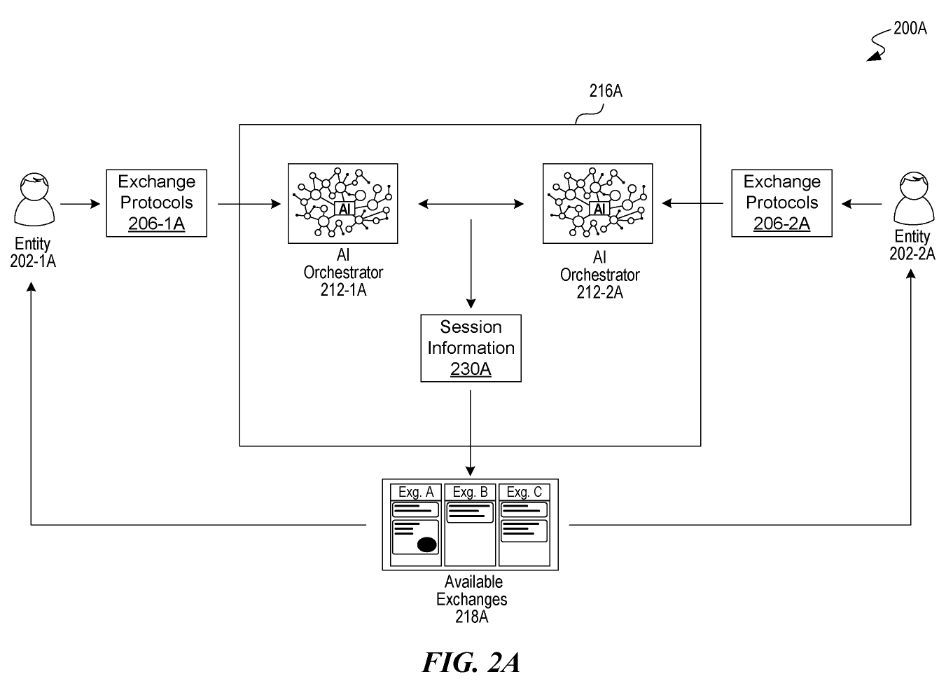

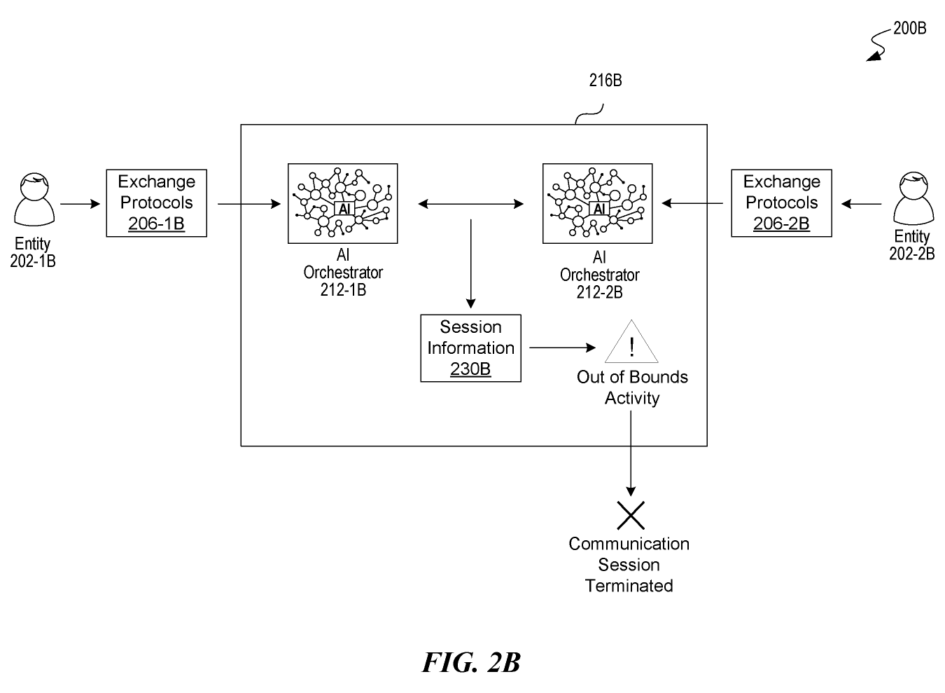

FIG. 2A is an example communication environment 200A including a communication session 216A in which a first AI orchestrator 212-1A and a second AI orchestrator 212-2A communicate with one another, in accordance with some implementations of the present technology. The communication environment 200A includes a first entity 202-1A associated with a first set of exchange protocols 206-1A and a second entity 202-2A associated with a second set of exchange protocols 206-2A. The first entity 202-1A and the second entity 202-2A are different entities as described in relation to FIG. 1 above. Likewise, the sets of exchange protocols 206-1A, 206-2A can be the same as or generally similar to the set of exchange protocols 106 described in relation to FIG. 1. As depicted, the first set of exchange protocols 206-1A is provided, as input, to a first AI orchestrator 212-1A and the second set of exchange protocols 206-2A is provided, as input, to a second AI orchestrator 212-2A. The AI orchestrators 212-1A, 212-2A can be the same as or generally similar to the first AI orchestrator 112-1 and/or second AI orchestrator 112-2 of FIG. 1, except that the AI orchestrators 212-1A, 212-2A are specifically designated to act on behalf of the first entity 202-1A and the second entity 202-2A, respectively, during communication sessions.

As depicted in FIG. 2A, a communication session 216A is established between the first AI orchestrator 212-1A and the second AI orchestrator 212-2A, during which information is exchanged between the AI orchestrators 212-1A, 212-2A. For example, the communication session 216A can be the same as or generally similar to the communication session 116 described in relation to FIG. 1 above and the information can be exchanged to determine a set of available exchanges 218A for transferring at least one resource between the entities 202-1A, 202-2A. The set of available exchanges 218A can be the same as or generally similar to the set of available exchanges 118 described in relation to FIG. 1 above. In some implementations, when the communication session 216A is established, the communication session 216A is encrypted (e.g., using end-to-end encryption techniques) by an exchange management platform hosting the communication session 216A (e.g., the exchange management platform 104 described in relation to FIG. 1 above) to help prevent information exchanged therein from being discovered by unauthorized parties.

During the communication session 216A, the first AI orchestrator 212-1A can provide information to the second AI orchestrator 212-2A in accordance with the first set of exchange protocols 206-1A and the second AI orchestrator 212-2A can provide information to the first AI orchestrator 212-1A in accordance with the second set of exchange protocols 206-2A, thereby resulting in the generation of session information 230A, which is a record of the communications between the AI orchestrators 212-1A, 212-2A. Although the entities 202-1A, 202-2A do not participate in the communication session 216A directly, because the AI orchestrators 212-1A, 212-2A communicate based on various protocols determined by the entities 202-1A, 202-2A, the preferences of both entities 202-1A, 202-2A for types of resources to exchange, amounts of resources to exchange, information to disclose, and the like, are satisfied during the generation of the session information 230A.

In some implementations, the session information 230A includes private information about the entities 202-1A, 202-2A, such as a preference for a particular resource, an amount of a resource possessed, a negotiation style for discovering available exchanges, and the like, as this private information, in such implementations, must be shared between the AI orchestrators 212-1A, 212-2A to determine the set of available exchanges 218A (e.g., a set of exchanges that are mutually acceptable by/desirable to both the first entity 202-1A and the second entity 202-2A). However, privacy of the entities 202-1A, 202-2A can be protected by providing the set of available exchanges 218A to the first entity 202-1A and/or the second entity 202-2A in a manner that does not reveal additional, private information included in the session information 230A. For example, the set of available exchanges 218A can be displayed via a graphical layout (e.g., the graphical layout 120) without displaying other information from the session information 230A. Thus, the entities 202-1A, 202-2A can be informed of available exchanges as determined within the communication session 216A without revealing private information to each other, preserving privacy in a more robust manner than methods of discovering available exchanges that include providing information to human entities.

FIG. 2B is another example communication environment 200B including a communication session 216B in which a first AI orchestrator 212-1B and a second AI orchestrator 212-2B communicate with one another, in accordance with some implementations of the present technology. The entities 202-1B, 202-2B, the sets of exchange protocols 206-1B, 206-2B, the AI orchestrators 212-1B, 212-2B, the communication session 216B, and the session information 230B included in the communication environment 200B can all be the same as or generally similar to their corresponding components in FIG. 2A, except that the session information 230B indicates that an out of bounds activity has been performed by one or both of the AI orchestrators 212-1B, 212-2B. An out of bounds activity is an interaction that is limited or prohibited by an exchange management platform hosting the communication session 216B (e.g., the exchange management platform 104 described in relation to FIG. 1 above) for the purposes of preventing crashes, spam, and/or fraudulent activity on the exchange management platform.

In some implementations, the exchange management platform monitors the communication session 216B for out of bounds activity and, upon obtaining an indicator of the out of bounds activity from the communication session 216B (e.g., obtaining particular data included in the session information 230B), the exchange management platform terminates the communication session 216B. For example, the indicator can be data that, when processed by a rate limiter, a spam scoring algorithm, and/or another algorithm for detecting out of bounds activity of the exchange management platform, signals that an out of bounds activity has occurred. As depicted in FIG. 2B, this termination can occur before a set of available exchanges is generated based on the session information 230B, thereby helping to prevent the transmission of false or otherwise fraudulent reports of available exchanges to the entities 202-1B and 202-2B. Furthermore, terminating the communication session 216B improves the operating efficiency of the exchange management platform, as crashes are less likely to occur and bandwidth on the platform is more likely to be conserved for communication sessions that can lead to legitimate/successful exchanges of resources.

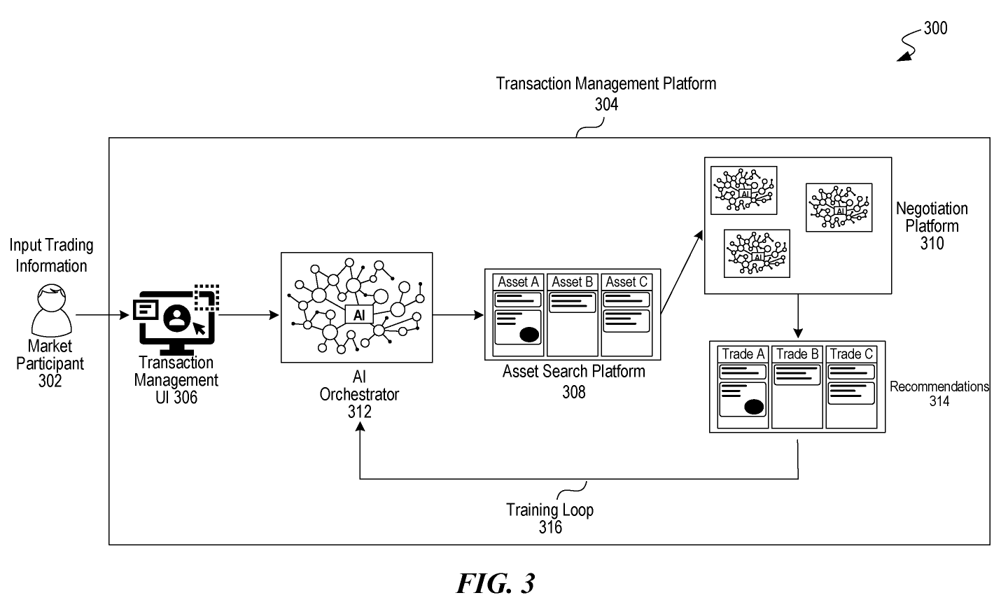

FIG. 3 shows an example computing environment 300 that includes a transaction management platform 304, in accordance with some implementations of the present technology. The computing environment 300 and transaction management platform 304 are generally similar to the computing environment 100 and exchange management platform 104, respectively, described in relation to FIG. 1 above, except that the computing environment 300 and transaction management platform 304 are used for the specific purpose of trading financial assets. The computing environment 300 includes a market participant 302, the transaction management platform 304, a transaction management user interface (UI) 306, an asset search platform 308, a negotiation platform 310, an AI orchestrator 312, recommendations 314, and training loop 316. The transaction management platform 304 can be implemented using components of the example computer system illustrated and described in more detail with reference to FIG. 7. Likewise, implementations of the example computing environment 300 can include different and/or additional components or can be connected in different ways.

The market participant 302 can be an individual or entity (e.g., the first entity 102-1 or second entity 102-2 described in relation to FIG. 1 above) interacting with the transaction management platform 304, providing input data such as available inventory of financial assets and desired transactions and engaging with the transaction management UI 306 to initiate and manage the transaction process. For example, a market participant 302 such as a portfolio manager or trader can upload a document and/or image indicating (e.g., via a URL or spreadsheet) the transaction preferences of the market participant 302 via a list of desired transactions the market participant 302 would like to execute. Examples of potential assets to trade on the transaction management platform 304 include any illiquid asset, such as corporate bonds, private credit, municipal bonds, and OTC swaps. The input data can also include a set of exchange protocols 106, as described in relation to FIG. 1 above.

The transaction management UI 306 of the transaction management platform 304 enables the market participant 302 to interact with the transaction management platform 304. The transaction management UI 306 allows the market participant 302 to input documents, view recommendations 314, and/or manage the transaction process. In some implementations, the transaction management UI 306 provides a graphical layout (e.g., the graphical layout 120 described in relation to FIG. 1 above) indicating the status of an AI orchestrator 312 associated with the market participant 302, information about other market participants from the asset search platform 308, and recommendations 314 made by the AI orchestrator 312 for interpretation and decision-making by the market participant 302. For example, the transaction management UI 306 can display a status update associated with the AI orchestrator 312 (e.g., indicating whether the AI orchestrator 312 is awaiting instructions or has produced the recommendation 314). The asset search platform 308 integrates with the transaction management platform 304 to provide relevant data (e.g., quantity, price, and type of assets being offered by market participants) to the transaction management UI 306.

The transaction management platform 304 uses one or more AI orchestrators, including the AI orchestrator 312, to process the input data entered by the market participant 302 via the transaction management UI 306 to dynamically identify and negotiate transactions that are of interest to the market participant 302. The AI orchestrator 312 can execute an AI model trained to negotiate asset transactions and make the recommendations 314. For example, the AI orchestrator 312 can be a neural network, decision tree, or other machine learning (ML) algorithm trained on historical transaction data. The AI orchestrator 312 can recognize patterns and correlations within the set of input data provided by a market participant 302, enabling the AI orchestrator 312 to identify the asset transactions the market participant 302 may be interested in executing. The AI orchestrator 312 can use techniques such as natural language processing (NLP) to interpret textual data within the set of input data and feature extraction to identify variables influencing transaction prioritization. For instance, NLP can be used to analyze descriptions of transaction preferences and extract keywords that indicate instructions, prices, asset classes, and so forth. In some implementations, an API gives a market participant 302 programmatic access to the transaction management platform 304, allowing for the upload of an AI model chosen by the market participant 302 to be used/executed by the AI orchestrator 312 associated with that market participant 302. The AI orchestrator 312 can be the same as or generally similar to the first AI orchestrator 112-1 and/or second AI orchestrator 112-2 described in relation to FIG. 1 above.

In some implementations, once the AI orchestrator 312 processes the input data from an associated market participant 302, the AI orchestrator 312 searches the asset search platform 308 to discover inventory or transaction ideas that counterparties, or other non-affiliated market participants, have made public and that align with the transaction preferences of the market participant 302. For example, the asset search platform 308 can include a knowledge graph that is the same as or generally similar to the knowledge graph 110 described in relation to FIG. 1 above and is searched in a same or generally similar manner. When the AI orchestrator 312 identifies one or more counterparties that have provided information on the asset search platform 308 indicating the one or more counterparties might enter into a transaction desirable to the market participant 302, the AI orchestrator 312 is connected to one or more counterparty AI orchestrators associated with the one or more identified counterparties via a negotiation platform 310. When more than one such connection is made, the AI orchestrator 312 will initiate and carry out multiple negotiations with all connected counterparty AI orchestrators simultaneously, enabling more rapid identification of available transactions than manual techniques or automated techniques in which negotiations are carried out sequentially. The connections made by the AI orchestrator 312 within the negotiation platform 310 can be communication sessions, as described in relation to the communication session 116 of FIG. 1 above.

In some implementations, the AI orchestrators connected to one another via the negotiation platform 310 then share information about the transaction preferences of the market participants with which the AI orchestrators are respectively associated and determine, based on the shared information, whether a mutually acceptable exchange between the market participants is available. For example, the AI orchestrator 312 may intelligently reveal and conditionally share information based upon how the negotiations between the AI orchestrator 312 and a counterparty AI orchestrator are progressing. Specific relevant criteria for conditionally revealing more information may include an analysis of how credible the AI orchestrator perceives a counterparty to be and how likely the counterparty is to execute a transaction with the market participant for a particular financial instrument. As each negotiation between AI orchestrators advances closer to a match and the perceived probability of a match for each side increases, the willingness of each AI orchestrator to share more information about trading intentions and available inventory can dynamically adjust to facilitate completion of a transaction. Where the AI orchestrator 312 no longer believes there is a credible probability of a transaction occurring that justifies the risk of more information sharing, the AI orchestrator 312 can end the negotiation.

In some implementations, the negotiation platform 310 uses a credentialing system to determine the confidentiality of certain information shared during a negotiation between two AI orchestrators. For example, the market participant 302 can designate that the identity of the market participant 302 not be shared during a negotiation, in which case the credentialing system would hide this identity from AI orchestrators associated with other market participants. As another example, one or more market participants can designate that none of the information shared by an associated AI orchestrator during negotiations be available to counterparties, in which case the negotiation details would be hidden from counterparties but transaction ideas resulting from those negotiations could still be shared.

The recommendations 314 can include one or more available exchanges identified via one or more negotiations performed by the AI orchestrator 312 via the negotiation platform 310. Each recommendation represents a transaction that the AI orchestrator 312 determined would be acceptable both to the market participant 302 and to a counterparty. The recommendations 314 can be displayed in the transaction management UI 306, showing, for example, the price at which a transaction is available and the quantity of each type of asset involved in the transaction. In some implementations, the market participant 302 authorizes an associated AI orchestrator 312 to execute a transaction corresponding to an available exchange on behalf of the market participant 302, allowing a transaction with the same terms included in the available exchange to be executed nearly instantaneously after a negotiation is finalized. For example, the recommendations 314 can include an available exchange generally similar to those included in the set of available exchanges 118 described in relation to FIG. 1 above.

The training loop 316 allows the transaction management platform 304 to iteratively train the AI orchestrator 312. The training loop 316 allows the AI orchestrator 312 to continuously learn from new data and adapt to changes in the trading strategy of a market participant, maintaining the effectiveness of the transaction management platform 304. For instance, if the AI orchestrator 312 initially misclassifies the asset a market participant 302 wishes to acquire, the training loop 316 allows the AI orchestrator 312 to adjust the relevant parameters to improve future asset classifications using information learned from the misclassification. The training loop 316 can perform one or more of the training processes described in more detail below.

### Example Method of Operation of the Exchange Management Platform

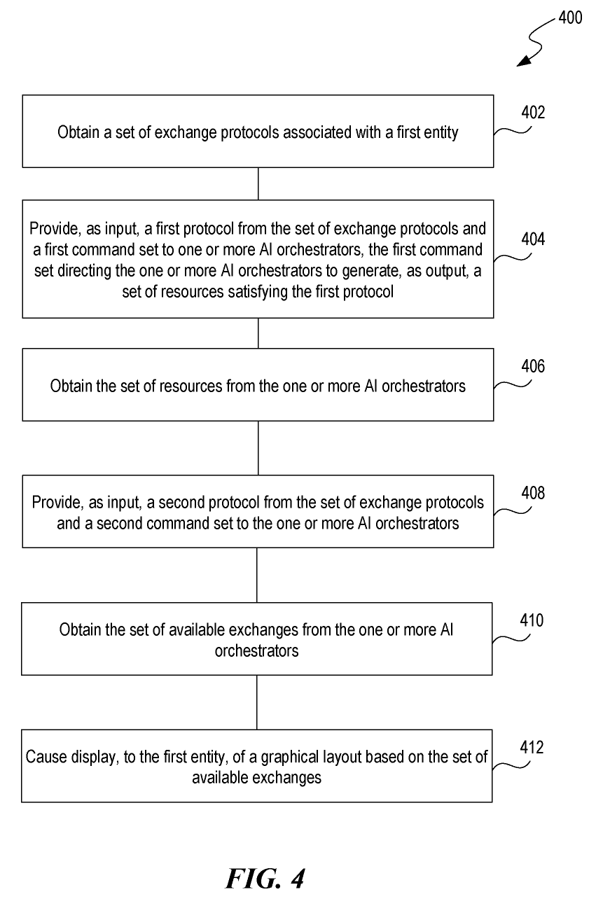

FIG. 4 is a flowchart depicting an example method 400 of facilitating exchanges between entities using AI orchestrators, in accordance with some implementations of the present technology. In some implementations, the method 400 is performed by components of the example computer system illustrated and described in more detail in relation to FIG. 7 below and/or the exchange management platform 104 described in relation to FIG. 1 above. Likewise, implementations can include different and/or additional operations or can perform the operations in different orders.

In operation 402, a set of exchange protocols associated with a first entity is obtained. The set of exchange protocols can be the same as or generally similar to the set of exchange protocols 106 as described in relation to FIG. 1 above. The first entity can be the same as or generally similar to the first entity 102-1 as described in relation to FIG. 1 above. In some implementations, the set of exchange protocols is scraped from a database maintained by the first entity indicating preferred exchange protocols of the first entity. The set of exchange protocols can include a data quality protocol, an exchange type protocol, a regulatory protocol, a privacy protocol, and/or an exchange discovery protocol.

In operation 404, a first protocol from the set of exchange protocols and a first command set are provided, as input, to one or more AI orchestrators, the first command set directing the one or more AI orchestrators to generate, as output, a set of resources satisfying the first protocol. The first protocol can specify a data quality protocol and at least one of an exchange type protocol or a regulatory protocol. The first command set can be a set of machine-readable and/or natural language instructions directing the one or more AI orchestrators to generate a set of queries for searching a subset of a knowledge graph for the set of resources. The one or more AI orchestrators can be the same as or generally similar to the first AI orchestrator 112-1 as described in relation to FIG. 1 above. In some implementations, the one or more AI orchestrators search a knowledge graph by generating a set of queries (e.g., by executing a set of predefined tools) and searching, using the set of queries, a subset of the knowledge graph for the set of resources, with the subset being based on the set of exchange protocols. In these and other implementations, an analysis orchestrator from the one or more AI orchestrators generates, according to a set of constraints provided by a compliance orchestrator from the one or more AI orchestrators, the set of resources. In some implementations, a plurality of resource indicators is stored in a knowledge graph, wherein at least one resource indicator from the plurality of resource indicators represents a resource associated with a second entity, and wherein the set of resources is selected, by the one or more AI orchestrators, from the knowledge graph.

In operation 406, the set of resources is obtained from the one or more AI orchestrators. The set of resources can include resources that satisfy the first protocol and are available for exchange with other entities via an exchange management platform, such as the exchange management platform 104 described in relation to FIG. 1 above.

In operation 408, a second protocol from the set of exchange protocols and a second command set are provided, as input, to the one or more AI orchestrators. The second command set can direct the one or more AI orchestrators to (1) establish a communication session with a second AI orchestrator associated with a second entity, (2) during the communication session, provide information in accordance with the second protocol to the second AI orchestrator, and (3) determine, based on the communication session, a set of available exchanges for transferring the resource from the second entity to the first entity. The second protocol can specify at least one of an exchange discovery protocol or a privacy protocol. The second entity can be the same as or generally similar to the second entity 102-2 as described in relation to FIG. 1 above. The second AI orchestrator can be the same as or generally similar to either of the AI orchestrators 212-1A, 212-2A as described in relation to FIG. 2A above. The communication session can be the same as or generally similar to the communication session 116 as described in relation to FIG. 1 above. In some implementations, during the communication session, the second AI orchestrator provides information to the one or more AI orchestrators in accordance with a third protocol associated with the second entity. In other implementations, an exchange discovery orchestrator from the one or more AI orchestrators establishes the communication session and provides the information during the communication session.

In operation 410, the set of available exchanges is obtained from the one or more AI orchestrators. The set of available exchanges can be the same as or generally similar to the set of available exchanges 118 as described in relation to FIG. 1 above.

In operation 412, display, to the first entity, is caused of a graphical layout based on the set of available exchanges. The graphical layout can be the same as or generally similar to the graphical layout 120 as described in relation to FIG. 1 above. The graphical layout can exclude information from the communication session other than the set of available exchanges, thereby helping to preserve privacy of the first entity and the second entity. In some implementations, a second communication session generally similar to the communication session is established by the one or more AI orchestrators, is encrypted and monitored for out of bounds activity by an exchange management platform, and, upon obtaining an indicator of the out of bounds activity from the second communication session, the exchange management platform terminates the second communication session before a second set of available exchanges is determined based on the second communication session.

### Transformer for Neural Network

To assist in understanding the present disclosure, some concepts relevant to neural networks and ML are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term “DNN” may encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification) in order to improve the accuracy of outputs (e.g., more accurate predictions) such as, for example, compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a language model), the training dataset may be a collection of text documents, referred to as a text corpus (or simply referred to as a corpus). The corpus may represent a language domain (e.g., a single language), may represent a subject domain (e.g., scientific papers), and/or may encompass another domain or domains, be they larger or smaller than a single language or subject domain. For example, a relatively large, multilingual, and non-subject-specific corpus may be created by extracting text from online web pages and/or publicly available social media posts. Training data may be annotated with ground truth labels (e.g., each data entry in the training dataset may be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder) or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger dataset. For example, a dataset may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model’s accuracy. Other segmentations of the larger dataset and/or schemes for using the segments for training one or more ML models are possible.

Backpropagation is an algorithm for training an ML model. Backpropagation is used to adjust (also referred to as update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses large language models (LLMs).

A language model may use a neural network (typically a DNN) to perform NLP tasks. A language model may be trained to model how words relate to each other in a textual sequence, based on probabilities. A language model may contain hundreds of thousands of learned parameters or, in the case of an LLM, may contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as RNN-based language models.

FIG. 5 is a block diagram 500 of an example transformer 512, in accordance with some implementations of the present technology. A transformer is a type of neural network architecture that uses self-attention mechanisms to generate predicted output based on input data that has some sequential meaning (i.e., the order of the input data is meaningful, which is the case for most text input). Self-attention is a mechanism that relates different positions of a single sequence to compute a representation of the same sequence. Although transformer-based language models are described herein, it should be understood that the present disclosure may be applicable to any ML-based language model, including language models based on other neural network architectures such as RNN-based language models.

The transformer 512 includes an encoder 508 (which can comprise one or more encoder layers/blocks connected in series) and a decoder 510 (which can comprise one or more decoder layers/blocks connected in series). Generally, the encoder 508 and the decoder 510 each include a plurality of neural network layers, at least one of which can be a self-attention layer. The parameters of the neural network layers can be referred to as the parameters of the language model.

The transformer 512 can be trained to perform certain functions on a natural language input. For example, the functions include summarizing existing content, brainstorming ideas, writing a rough draft, fixing spelling and grammar, and translating content. Summarizing can include extracting key points from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user’s writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 512 is trained to perform certain functions on other input formats than natural language input. For example, the input can include objects, images, audio content, or video content, or a combination thereof.

The transformer 512 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input). FIG. 5 illustrates an example of how the transformer 512 can process textual input data. Input to a language model (whether transformer-based or otherwise) typically is in the form of natural language that can be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some examples, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 5, a short sequence of tokens 502 corresponding to the input text is illustrated as input to the transformer 512. Tokenization of the text sequence into the tokens 502 can be performed by some pre-processing tokenization module such as, for example, a byte-pair encoding tokenizer (the “pre” referring to the tokenization occurring prior to the processing of the tokenized input by the LLM), which is not shown in FIG. 5 for simplicity. In general, the token sequence that is inputted to the transformer 512 can be of any length up to a maximum length defined based on the dimensions of the transformer 512. Each token 502 in the token sequence is converted into an embedding vector 506 (also referred to simply as an embedding 506). An embedding 506 is a learned numerical representation (such as, for example, a vector) of a token that captures some semantic meaning of the text segment represented by the token 502. The embedding 506 represents the text segment corresponding to the token 502 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 506 corresponding to the “write” token will be closer to another embedding corresponding to the “jot down” token in the vector space as compared to the distance between the embedding 506 corresponding to the “write” token and another embedding corresponding to the “summary” token.

The vector space can be defined by the dimensions and values of the embedding vectors. Various techniques can be used to convert a token 502 to an embedding 506. For example, another trained ML model can be used to convert the token 502 into an embedding 506. In particular, another trained ML model can be used to convert the token 502 into an embedding 506 in a way that encodes additional information into the embedding 506 (e.g., a trained ML model can encode positional information about the position of the token 502 in the text sequence into the embedding 506). In some examples, the numerical value of the token 502 can be used to look up the corresponding embedding in an embedding matrix 504 (which can be learned during training of the transformer 512).

The generated embeddings 506 are input into the encoder 508. The encoder 508 serves to encode the embeddings 506 into feature vectors 514 that represent the latent features of the embeddings 506. The encoder 508 can encode positional information (i.e., information about the sequence of the input) in the feature vectors 514. The feature vectors 514 can have very high dimensionality (e.g., on the order of thousands or tens of thousands), with each element in a feature vector 514 corresponding to a respective feature. The numerical weight of each element in a feature vector 514 represents the importance of the corresponding feature. The space of all possible feature vectors 514 that can be generated by the encoder 508 can be referred to as the latent space or feature space.

Conceptually, the decoder 510 is designed to map the features represented by the feature vectors 514 into meaningful output, which can depend on the task that was assigned to the transformer 512. For example, if the transformer 512 is used for a translation task, the decoder 510 can map the feature vectors 514 into text output in a target language different from the language of the original tokens 502. Generally, in a generative language model, the decoder 510 serves to decode the feature vectors 514 into a sequence of tokens. The decoder 510 can generate output tokens 516 one by one. Each output token 516 can be fed back as input to the decoder 510 in order to generate the next output token 516. By feeding back the generated output and applying self-attention, the decoder 510 is able to generate a sequence of output tokens 516 that has sequential meaning (e.g., the resulting output text sequence is understandable as a sentence and obeys grammatical rules). The decoder 510 can generate output tokens 516 until a special [EOT] token (indicating the end of the text) is generated. The resulting sequence of output tokens 516 can then be converted to a text sequence in post-processing. For example, each output token 516 can be an integer number that corresponds to a vocabulary index. By looking up the text segment using the vocabulary index, the text segment corresponding to each output token 516 can be retrieved, the text segments can be concatenated together, and the final output text sequence can be obtained.

In some examples, the input provided to the transformer 512 includes instructions to perform a function on an existing text. In some examples, the input provided to the transformer includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text. For example, the input can include the question “What is the weather like in Australia?” and the output can include a description of the weather in Australia.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an application programming interface (API)). Additionally or alternatively, such a remote language model can be accessed via a network such as, for example, the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via its API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Artificial Intelligence System

FIG. 6 is a block diagram that illustrates an example of an AI system 600 in which at least some operations described herein can be implemented. Example ML models can include one or models executed by the AI orchestrators 112-1, 112-2, 212-1A, 212-2A, 212-1B, 212-2B described in relation to FIGS. 1, 2A, and 2B. Accordingly, AI orchestrators 112-1, 112-2, 212-1A, 212-2A, 212-1B, 212-2B can include one or more components of the AI system 600.

As shown in FIG. 6, the AI system 600 can include a set of layers, which conceptually organize elements within an example network topology for the AI system’s architecture to implement a particular AI model 630. Generally, an AI model 630 is a computer-executable program implemented by the AI system 600 that analyzes data to make predictions. Information can pass through each layer of the AI system 600 to generate outputs for the AI model 630. The layers can include a data layer 602, a structure layer 604, a model layer 606, and an application layer 608. The algorithm 616 of the structure layer 604 and the model structure 620 and model parameters 622 of the model layer 606 together form the example AI model 630. The optimizer 626, loss function engine 624, and regularization engine 628 work to refine and optimize the AI model 630, and the data layer 602 provides resources and support for application of the AI model 630 by the application layer 608.

The data layer 602 acts as the foundation of the AI system 600 by preparing data for the AI model 630. As shown, the data layer 602 can include two sub-layers: a hardware platform 610 and one or more software libraries 612. The hardware platform 610 can be designed to perform operations for the AI model 630 and include computing resources for storage, memory, logic, and networking. The hardware platform 610 can process amounts of data using one or more servers. The servers can perform backend operations such as matrix calculations, parallel calculations, ML training, and the like. Examples of servers used by the hardware platform 610 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 610 can include Infrastructure as a Service (IaaS) resources, which are computing resources (e.g., servers, memory, etc.) offered by a cloud services provider. The hardware platform 610 can also include computer memory for storing data about the AI model 630, application of the AI model 630, and training data for the AI model 630. The computer memory can be a form of random-access memory (RAM), such as dynamic RAM, static RAM, and non-volatile RAM.

The software libraries 612 can be thought of as suites of data and programming code, including executables, used to control the computing resources of the hardware platform 610. The programming code can include low-level primitives (e.g., fundamental language elements) that form the foundation of one or more low-level programming languages such that servers of the hardware platform 610 can use the low-level primitives to carry out specific operations. The low-level programming languages do not require much, if any, abstraction from a computing resource’s instruction set architecture, allowing them to run quickly with a small memory footprint. Examples of software libraries 612 that can be included in the AI system 600 include Intel Math Kernel Library, Nvidia cuDNN, Eigen, and OpenBLAS.

The structure layer 604 can include an ML framework 614 and an algorithm 616. The ML framework 614 can be thought of as an interface, library, or tool that allows users to build and deploy the AI model 630. The ML framework 614 can include an open-source library, an API, a gradient-boosting library, an ensemble method, and/or a deep learning toolkit that work with the layers of the AI system to facilitate development of the AI model 630. For example, the ML framework 614 can distribute processes for application or training of the AI model 630 across multiple resources in the hardware platform 610. The ML framework 614 can also include a set of pre-built components that have the functionality to implement and train the AI model 630 and allow users to use pre-built functions and classes to construct and train the AI model 630. Thus, the ML framework 614 can be used to facilitate data engineering, development, hyperparameter tuning, testing, and training for the AI model 630. Examples of ML frameworks 614 that can be used in the AI system 600 include TensorFlow, PyTorch, Scikit-Learn, Keras, Caffe, LightGBM, Random Forest, and Amazon Web Services.

The algorithm 616 can be an organized set of computer-executable operations used to generate output data from a set of input data and can be described using pseudocode. The algorithm 616 can include complex code that allows the computing resources to learn from new input data and create new/modified outputs based on what was learned. In some implementations, the algorithm 616 can build the AI model 630 through being trained while running computing resources of the hardware platform 610. This training allows the algorithm 616 to make predictions or decisions without being explicitly programmed to do so. Once trained, the algorithm 616 can run at the computing resources as part of the AI model 630 to make predictions or decisions, improve computing resource performance, or perform tasks. The algorithm 616 can be trained using supervised learning, unsupervised learning, semi-supervised learning, and/or reinforcement learning.

Using supervised learning, the algorithm 616 can be trained to learn patterns (e.g., map input data to output data) based on labeled training data. The training data may be labeled by an external user or operator. For instance, a user may collect a set of training data, such as by capturing data from sensors, images from a camera, outputs from a model, and the like. In an example implementation, training data can include asset tracking histories with known threat levels, resources with known relevancy scores measuring their relevance to known assets, and logs of physical and digital features with known correspondences and similarities. The user may label the training data based on one or more classes and train the AI model 630 by inputting the training data to the algorithm 616. The algorithm determines how to label the new data based on the labeled training data. The user can facilitate collection, labeling, and/or input via the ML framework 614. In some instances, the user may convert the training data to a set of feature vectors for input to the algorithm 616. Once trained, the user can test the algorithm 616 on new data to determine if the algorithm 616 is predicting accurate labels for the new data. For example, the user can use cross-validation methods to test the accuracy of the algorithm 616 and retrain the algorithm 616 on new training data if the results of the cross-validation are below an accuracy threshold.

Supervised learning can involve classification and/or regression. Classification techniques involve teaching the algorithm 616 to identify a category of new observations based on training data and are used when input data for the algorithm 616 is discrete. Said differently, when learning through classification techniques, the algorithm 616 receives training data labeled with categories (e.g., classes) and determines how features observed in the training data (e.g., service name, asset room location, asset internet protocol (IP) address) relate to the categories (e.g., high risk or low risk of cybersecurity attack). Once trained, the algorithm 616 can categorize new data by analyzing the new data for features that map to the categories. Examples of classification techniques include boosting, decision tree learning, genetic programming, learning vector quantization, k-nearest neighbor (k-NN) algorithm, and statistical classification.

Regression techniques involve estimating relationships between independent and dependent variables and are used when input data to the algorithm 616 is continuous. Regression techniques can be used to train the algorithm 616 to predict or forecast relationships between variables. To train the algorithm 616 using regression techniques, a user can select a regression method for estimating the parameters of the model. The user collects and labels training data that is input to the algorithm 616 such that the algorithm 616 is trained to understand the relationship between data features and the dependent variable(s). Once trained, the algorithm 616 can predict missing historic data or future outcomes based on input data. Examples of regression methods include linear regression, multiple linear regression, logistic regression, regression tree analysis, least squares method, and gradient descent. In an example implementation, regression techniques can be used, for example, to estimate and fill in missing data for ML-based pre-processing operations.

Under unsupervised learning, the algorithm 616 learns patterns from unlabeled training data. In particular, the algorithm 616 is trained to learn hidden patterns and insights of input data, which can be used for data exploration or for generating new data. Here, the algorithm 616 does not have a predefined output, unlike the labels output when the algorithm 616 is trained using supervised learning. Said another way, unsupervised learning is used to train the algorithm 616 to find an underlying structure of a set of data, group the data according to similarities, and represent that set of data in a compressed format. In some implementations, performance of the algorithm 616 that can use unsupervised learning is improved because it can learn how to fine-tune the model by setting an ideal cutoff score for relevancy rank, as described herein.

A few techniques can be used in supervised learning: clustering, anomaly detection, and techniques for learning latent variable models. Clustering techniques involve grouping data into different clusters that include similar data such that other clusters contain dissimilar data. For example, during clustering, data with possible similarities remain in a group that has less or no similarities to another group. Examples of clustering techniques include density-based methods, hierarchical-based methods, partitioning methods, and grid-based methods. In one example, the algorithm 616 may be trained to be a k-means clustering algorithm, which partitions n observations in k clusters such that each observation belongs to the cluster with the nearest mean serving as a prototype of the cluster. Anomaly detection techniques are used to detect previously unseen rare objects or events represented in data without prior knowledge of these objects or events. Anomalies can include data that occur rarely in a set, a deviation from other observations, outliers that are inconsistent with the rest of the data, patterns that do not conform to well-defined normal behavior, and the like. When using anomaly detection techniques, the algorithm 616 may be trained to be an Isolation Forest, local outlier factor (LOF) algorithm, or k-NN algorithm. Latent variable techniques involve relating observable variables to a set of latent variables. These techniques assume that the observable variables are the result of an individual’s position on the latent variables and that the observable variables have nothing in common after controlling for the latent variables. Examples of latent variable techniques that may be used by the algorithm 616 include factor analysis, item response theory, latent profile analysis, and latent class analysis.

The model layer 606 implements the AI model 630 using data from the data layer 602 and the algorithm 616 and ML framework 614 from the structure layer 604, thus enabling decision-making capabilities of the AI system 600. The model layer 606 includes a model structure 620, model parameters 622, a loss function engine 624, an optimizer 626, and a regularization engine 628.

The model structure 620 describes the architecture of the AI model 630 of the AI system 600. The model structure 620 defines the complexity of the pattern/relationship that the AI model 630 expresses. Examples of structures that can be used as the model structure 620 include decision trees, support vector machines, regression analyses, Bayesian networks, Gaussian processes, genetic algorithms, and neural networks. The model structure 620 can include a number of structure layers, a number of nodes (or neurons) at each structure layer, and activation functions of each node. Each node’s activation function defines how the node converts data received to data output. The structure layers may include an input layer of nodes that receive input data and an output layer of nodes that produce output data. The model structure 620 may include one or more hidden layers of nodes between the input and output layers. The model structure 620 can be a neural network that connects the nodes in the structured layers such that the nodes are interconnected. Examples of neural networks include a transformer (e.g., the transformer 512, as described in relation to FIG. 5 above) or another neural network described above.

The model parameters 622 represent the relationships learned during training and can be used to make predictions and decisions based on input data. The model parameters 622 can weight and bias the nodes and connections of the model structure 620. For instance, when the model structure 620 is a neural network, the model parameters 622 can weight and bias the nodes in each layer of the neural networks such that the weights determine the strength of the nodes and the biases determine the thresholds for the activation functions of each node. The model parameters 622, in conjunction with the activation functions of the nodes, determine how input data is transformed into desired outputs. The model parameters 622 can be determined and/or altered during training of the algorithm 616.

The loss function engine 624 can determine a loss function, which is a metric used to evaluate the AI model’s 630 performance during training. For instance, the loss function engine 624 can measure the difference between a predicted output of the AI model 630 and the actual output of the AI model 630 and is used to guide optimization of the AI model 630 during training to minimize the loss function. The loss function may be presented via the ML framework 614 such that a user can determine whether to retrain or otherwise alter the algorithm 616 if the loss function is over a threshold. In some instances, the algorithm 616 can be retrained automatically if the loss function is over the threshold. Examples of loss functions include a binary-cross entropy function, hinge loss function, regression loss function (e.g., mean square error, quadratic loss, etc.), mean absolute error function, smooth mean absolute error function, log-cosh loss function, and quantile loss function.

The optimizer 626 adjusts the model parameters 622 to minimize the loss function during training of the algorithm 616. In other words, the optimizer 626 uses the loss function generated by the loss function engine 624 as a guide to determine what model parameters lead to the most accurate AI model 630. Examples of optimizers include Gradient Descent (GD), Adaptive Gradient Algorithm (AdaGrad), Adaptive Moment Estimation (Adam), Root Mean Square Propagation (RMSprop), Radial Base Function (RBF), and Limited-memory BFGS (L-BFGS). The type of optimizer 626 used may be determined based on the type of model structure 620 and the size of data and the computing resources available in the data layer 602.

The regularization engine 628 executes regularization operations. Regularization is a technique that prevents overfitting and underfitting of the AI model 630. Overfitting occurs when the algorithm 616 is overly complex and too adapted to the training data, which can result in poor performance of the AI model 630. Underfitting occurs when the algorithm 616 is unable to recognize even basic patterns from the training data such that it cannot perform well on training data or on validation data. The regularization engine 628 can apply one or more regularization techniques to fit the algorithm 616 to the training data properly, which helps constrain the resulting AI model 630 and improves its ability for generalized application. Examples of regularization techniques include lasso (L1) regularization, ridge (L2) regularization, and elastic (L1 and L2) regularization.

The application layer 608 describes how the AI system 600 is used to solve problems or perform tasks. In an example implementation, the application layer 608 can include the AI orchestrators 112-1, 112-2, 212-1A, 212-2A, 212-1B, 212-2B as described in relation to FIGS. 1, 2A, and 2B above.

### Computer System

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, a video display device 718, an I/O device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), augmented reality (AR)/virtual reality (VR) systems (e.g., head-mounted display), or any electronic device capable of executing a set of instructions that specify action(s) to be taken by the computing system 700. In some implementations, the computer system 700 can be an embedded computer system, a system-on-chip (SOC), a single-board computer (SBC) system, or a distributed system such as a mesh of computer systems, or it can include one or more cloud components in one or more networks. Where appropriate, one or more computer systems 700 can perform operations in real time, in near real time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable (storage) medium 726) can be local, remote, or distributed. Although shown as a single medium, the machine-readable (storage) medium 726 can include multiple media (e.g., a centralized/distributed database and/or associated caches and servers) that store one or more sets of instructions 728. The machine-readable (storage) medium 726 can include any medium that is capable of storing, encoding, or carrying a set of instructions for execution by the computing system 700. The machine-readable (storage) medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### Example Use Cases of the Transaction Management Platform

Various use cases for the transaction management platform in the context of illiquid financial asset trading are described above. In addition, the transaction management platform can be used to allow parties to securely exchange information in any context where secure exchanges are desirable. For example, in the cybersecurity industry, a technical problem with verifying the identity and authorizations of a user of a service is that a user often cannot be verified without sending sensitive personal information, such as a social security number, birth date, or home address, to the service the user is trying to access. Sending this sensitive information to the service requires the service to process and at least temporarily store the information, exposing the information to the threat of a security breach.

The credentialing system present in some implementations of the transaction management platform solves this technical problem because it allows for identity verification to occur without sensitive personal information leaving the secure transaction management platform. For example, rather than sending sensitive personal information to a potentially unsecure service, a user can upload the information to the transaction management platform, which uses an AI orchestrator to convey that information to another AI orchestrator representing the service. The AI orchestrators would then determine whether the user’s identity can be verified and what authorizations the user has pertaining to the service. The AI orchestrator representing the service would then report to the service whether the user was verified and the authorizations the user should be granted without directly sharing the sensitive personal information used for this verification with the service. Likewise, the exchange management platform described herein can be used to allow parties to securely exchange information in any context where secure exchanges are desirable.

### Conclusion

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variants thereof mean any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples of the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include additional elements to those implementations noted above or may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, specific terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right after filing this application to pursue such additional claim forms, either in this application or in a continuing application.

We claim:

1. One or more non-transitory, computer-readable storage media comprising instructions recorded thereon, wherein the instructions, when executed by at least one data processor of a system, cause the system to:
obtain a set of exchange protocols associated with a first entity,
wherein a first protocol in the set of exchange protocols specifies a data quality protocol and at least one of an exchange type protocol or a regulatory protocol, and
wherein a second protocol in the set of exchange protocols specifies at least a privacy protocol and an exchange discovery protocol;
access a plurality of resource indicators from a knowledge graph,
wherein at least one resource indicator from the plurality of resource indicators represents a resource associated with a second entity;
provide, as input, the first protocol and a first command set to one or more artificial intelligence (AI) orchestrators, the first command set directing the one or more AI orchestrators to:
generate, by executing one or more predefined tools, a set of queries, and
search, using the set of queries, a subset of the knowledge graph for a set of resources satisfying the first protocol, wherein the subset is based on the data quality protocol;
obtain the set of resources from the one or more AI orchestrators;
provide, as input, the second protocol and a second command set to the one or more AI orchestrators, the second command set directing the one or more AI orchestrators to:
establish a communication session with a second AI orchestrator associated with the second entity,
during the communication session, provide information in accordance with the second protocol to the second AI orchestrator, and
determine, based on the communication session, a set of available exchanges for transferring at least one resource from the set of resources from the second entity to the first entity;
obtain the set of available exchanges from the one or more AI orchestrators; and
cause display, to the first entity, of a graphical layout based on the set of available exchanges,
wherein the graphical layout excludes information from the communication session other than the set of available exchanges.

2. The one or more non-transitory, computer-readable storage media of claim 1, further comprising instructions causing the system to:
encrypt a second communication session established by the one or more AI orchestrators;
monitor the second communication session for out of bounds activity; and
upon obtaining an indicator of the out of bounds activity from the second communication session, terminate the second communication session before a second set of available exchanges is determined based on the second communication session.

3. The one or more non-transitory, computer-readable storage media of claim 1, further comprising instructions causing the system to:
store a communication log associated with the communication session in a communications database; and
provide, as input, the second protocol, the communication log, and a third command set to the one or more AI orchestrators, the third command set directing the one or more AI orchestrators to establish, based on the communication log, a second communication session with a third AI orchestrator associated with a third entity.

4. The one or more non-transitory, computer-readable storage media of claim 1, wherein, during the communication session, the second AI orchestrator provides information to the one or more AI orchestrators in accordance with a third protocol associated with the second entity.

5. The one or more non-transitory, computer-readable storage media of claim 1, wherein:
in response to the first command set, an analysis orchestrator from the one or more AI orchestrators searches, according to a set of constraints provided by a compliance orchestrator from the one or more AI orchestrators, the knowledge graph for the set of resources; and
in response to the second command set, an exchange discovery orchestrator from the one or more AI orchestrators (1) establishes the communication session and (2) provides the information during the communication session.

6. A system comprising:
at least one hardware processor; and
at least one non-transitory memory storing instructions, which, when executed by the at least one hardware processor, cause the system to:
obtain a set of exchange protocols associated with a first entity;
access a plurality of resource indicators from a knowledge graph,
wherein at least one resource indicator from the plurality of resource indicators represents a resource associated with a second entity;
provide, as input, a first protocol from the set of exchange protocols and a first command set to one or more artificial intelligence (AI) orchestrators, the first command set directing the one or more AI orchestrators to select, from the knowledge graph, a set of resources satisfying the first protocol;
obtain the set of resources from the one or more AI orchestrators;
provide, as input, a second protocol from the set of exchange protocols and a second command set to the one or more AI orchestrators, the second command set directing the one or more AI orchestrators to:
establish a communication session with a second AI orchestrator associated with the second entity,
during the communication session, provide information in accordance with the second protocol to the second AI orchestrator, and
determine, based on the communication session, a set of available exchanges for transferring the resource from the second entity to the first entity;
obtain the set of available exchanges from the one or more AI orchestrators; and
cause display, to the first entity, of a graphical layout based on the set of available exchanges.

7. The system of claim 6, wherein:
the first protocol specifies a data quality protocol and at least one of an exchange type protocol or a regulatory protocol; and
the second protocol specifies at least one of an exchange discovery protocol or a privacy protocol.

8. The system of claim 6, wherein the one or more AI orchestrators search the knowledge graph by:
generating, by executing one or more predefined tools, a set of queries, and
searching, using the set of queries, a subset of the knowledge graph for the set of resources, wherein the subset is based on the set of exchange protocols.

9. The system of claim 6, wherein the graphical layout excludes information from the communication session other than the set of available exchanges.

10. The system of claim 6, further comprising instructions causing the system to:
encrypt a second communication session established by the one or more AI orchestrators;
monitor the second communication session for out of bounds activity; and
upon obtaining an indicator of the out of bounds activity from the second communication session, terminate the second communication session before a second set of available exchanges is determined based on the second communication session.

11. The system of claim 6, further comprising instructions causing the system to:
store a communication log associated with the communication session in a communications database; and
provide, as input, the second protocol, the communication log, and a third command set to the one or more AI orchestrators, the third command set directing the one or more AI orchestrators to establish, based on the communication log, a second communication session with a third AI orchestrator associated with a third entity.

12. The system of claim 6, wherein, during the communication session, the second AI orchestrator provides information to the one or more AI orchestrators in accordance with a third protocol associated with the second entity.

13. The system of claim 6, wherein:
in response to the first command set, an analysis orchestrator from the one or more AI orchestrators searches, according to a set of constraints provided by a compliance orchestrator from the one or more AI orchestrators, the knowledge graph for the set of resources; and
in response to the second command set, an exchange discovery orchestrator from the one or more AI orchestrators (1) establishes the communication session and (2) provides the information during the communication session.

14. A method comprising:
obtaining a set of exchange protocols associated with a first entity;
providing, as input, a first protocol from the set of exchange protocols and a first command set to one or more artificial intelligence (AI) orchestrators, the first command set directing the one or more AI orchestrators to generate, as output, a set of resources satisfying the first protocol;
obtaining the set of resources from the one or more AI orchestrators;
providing, as input, a second protocol from the set of exchange protocols and a second command set to the one or more AI orchestrators, the second command set directing the one or more AI orchestrators to:
establish a communication session with a second AI orchestrator associated with a second entity,
during the communication session, provide information in accordance with the second protocol to the second AI orchestrator, and
determine, based on the communication session, a set of available exchanges for transferring the resource from the second entity to the first entity;
obtaining the set of available exchanges from the one or more AI orchestrators; and
causing display, to the first entity, of a graphical layout based on the set of available exchanges.

15. The method of claim 14, further comprising:
storing a plurality of resource indicators in a knowledge graph,
wherein at least one resource indicator from the plurality of resource indicators represents a resource associated with the second entity, and
wherein the set of resources is selected, by the one or more AI orchestrators, from the knowledge graph.

16. The method of claim 15, wherein the one or more AI orchestrators search the knowledge graph by:
generating, by executing one or more predefined tools, a set of queries; and
searching, using the set of queries, a subset of the knowledge graph for the set of resources, wherein the subset is based on the set of exchange protocols.

17. The method of claim 14, wherein:
the first protocol specifies a data quality protocol and at least one of an exchange type protocol or a regulatory protocol; and
the second protocol specifies at least one of an exchange discovery protocol or a privacy protocol.

18. The method of claim 14, wherein the graphical layout excludes information from the communication session other than the set of available exchanges.

19. The method of claim 14, further comprising:
encrypting a second communication session established by the one or more AI orchestrators;
monitoring the second communication session for out of bounds activity; and
upon obtaining an indicator of the out of bounds activity from the second communication session, terminating the second communication session before a second set of available exchanges is determined based on the second communication session.

20. The method of claim 14, wherein:
in response to the first command set, an analysis orchestrator from the one or more AI orchestrators generates, according to a set of constraints provided by a compliance orchestrator from the one or more AI orchestrators, the set of resources; and
in response to the second command set, an exchange discovery orchestrator from the one or more AI orchestrators (1) establishes the communication session and (2) provides the information during the communication session.
